(19) United States
(12) Patent Application Publication
(10) Pub. No.: US 2025/0287304 A1
(43) Pub. Date: Sep. 11, 2025

(54) INFORMATION PROCESSING APPARATUS AND DISPLAY METHOD

(71) Applicant: Sharp Kabushiki Kaisha, Osaka (JP)

(72) Inventor: Tatsuya WATABE, Osaka (JP)

(21) Appl. No.: 19/070,830

(22) Filed: Mar. 5, 2025

(30) Foreign Application Priority Data
Mar. 6, 2024 (JP) 2024-034222

(51) Int. Cl. H04W 52/02; H04L 43/045

(52) U.S. Cl. CPC H04W 52/0209; H04L 43/045

(57) ABSTRACT

An information processing apparatus, comprises: a communicator that connects to a network to transmit and receive communication data; a detector that detects a change in configuration of the network from the communication data received by the communicator; a determiner that determines, from the communication data, whether a Spanning Tree Protocol is applied to the network; and a display that displays a message to a user, based on a result of the determination made by the determiner.

### CROSS-REFERENCE TO RELATED APPLICATION

The present application claims priority from Japanese Application JP 2024-034222, the content to which is hereby incorporated by reference into this application.

### BACKGROUND OF THE INVENTION

### 1. Field of the Invention

The present disclosure relates to an information processing apparatus and the like.

### 2. Description of the Related Art

For example, there is known an information processing apparatus capable of establishing a network connection to perform a power saving control.

### SUMMARY OF THE INVENTION

An object of the present disclosure is to provide an information processing apparatus or the like capable of displaying a message depending on a network configuration so that a user can make an appropriate setting.

The information processing apparatus according to the present disclosure includes a communicator that connects to a network to transmit and receive communication data, a detector that detects a change in configuration of the network from the communication data received by the communicator, a determiner that determines, based on the communication data, whether a Spanning Tree Protocol is applied to the network, and a display that displays a message to a user, based on a result of the determination made by the determiner.

A display method according to the present disclosure includes connecting to a network to transmit and receive communication data, detecting a change in configuration of the network, determining whether a Spanning Tree Protocol is applied to the network, and displaying a message to a user, based on a result of the determination made in the determining.

According to the present disclosure, it is possible to provide an information processing apparatus or the like capable of displaying a message depending on a network configuration so that a user can make an appropriate setting.

### BRIEF DESCRIPTION OF THE DRAWINGS

FIG. 1 is a diagram for describing an overview of a display system according to a first embodiment.

FIG. 2 is a diagram for describing a hardware configuration of an information processing apparatus according to the first embodiment.

FIG. 3 is a diagram for describing a software configuration according to the first embodiment.

FIG. 4 is a diagram for describing an example of setting information according to the first embodiment.

FIG. 5 is a diagram for describing a processing flow according to the first embodiment.

FIG. 6A and FIG. 6B are diagrams for describing an example of an operation according to the first embodiment.

FIG. 7 is a diagram for describing a processing flow according to a second embodiment.

FIG. 8A and FIG. 8B are diagrams for describing an example of an operation according to the second embodiment.

FIG. 9 is a diagram for describing a processing flow according to a third embodiment.

FIG. 10 is a diagram for describing an example of an operation according to the third embodiment.

FIG. 11 is a diagram for describing a processing flow according to a fourth embodiment.

FIG. 12A and FIG. 12B are diagrams for describing an operation example according to the fourth embodiment.

FIG. 13 is a diagram for describing a processing flow according to a fifth embodiment.

FIG. 14A to FIG. 14C are diagrams for describing an example of an operation according to the fifth embodiment.

FIG. 15 is a diagram for describing a processing flow according to a sixth embodiment.

### DETAILED DESCRIPTION OF THE INVENTION

In general, an information processing apparatus executes various types of settings of the information processing apparatus in a controller. The controller stores, as setting information, information for executing the various types of settings into a storage. For example, in an image forming apparatus, which is a type of the information processing apparatus, if a power saving control is performed in the information processing apparatus, the power saving control may cause a problem depending on a network configuration.

For example, when the power save controlled is performed in the image forming apparatus in a network applied with a Spanning Tree Protocol (IEEE 802.1D), to perform the power saving control, examples of the power saving control include turning off a power supply to a communicator, and reducing a communication speed from a high speed such as GbE to a low speed such as 10BASE. The image forming apparatus being disconnected from the network by turning off the power supply to the communicator, or changing the communication speed mean that the configuration of the network is changed.

Thus, when the configuration of the network changes, for example, network devices complying with a Spanning Tree Protocol such as a router, an L3 switch, and an L2 switch often cut off a communication for approximately 30 to 60 seconds for reconfiguration.

To avoid such a communication cutoff, there is known an image forming apparatus for performing a control not to enter a power saving mode when such an apparatus detects application of the Spanning Tree Protocol to the network.

However, there is a Spanning Tree Protocol with a short communication cutoff time such as Rapid Spanning Tree Protocol (RSTP/IEEE 802.1w) and Multiple Spanning Tree Protocol (MSTP/IEEE 802.1Q). In a Spanning Tree environment applied with a Spanning Tree Protocol, if a control is performed so that the power saving mode is not uniformly entered in the image forming apparatuses, there is a problem that it is not possible to enter the power saving mode even in a network with a short communication cutoff time and a network configuration where it would be otherwise possible to enter the power saving mode. It is noted that as used herein, “extended STP” refers to a Spanning Tree Protocol extended from a Spanning Tree Protocol (IEEE 802.1D) such as RSTP or MSTP, and also includes a future Spanning Tree Protocol further extended other than RSTP and MSTP. The “environment” refers to a network environment applied with a protocol such as the Spanning Tree Protocol to the network.

An information processing apparatus according to the present disclosure will be described below in the following embodiments with reference to the drawings. It is noted that the following embodiments are merely examples of the disclosure described in the claims, and the technical scope of the present disclosure is not limited to the description of the following embodiments.

### 1. First Embodiment

A first embodiment will be described below. In the first embodiment, the following will be described for an example. In the following embodiments, a case will be described in which the information processing apparatus of the present disclosure is applied to an image forming apparatus, but may also be applied to other apparatuses.

### 1.1 Overall System

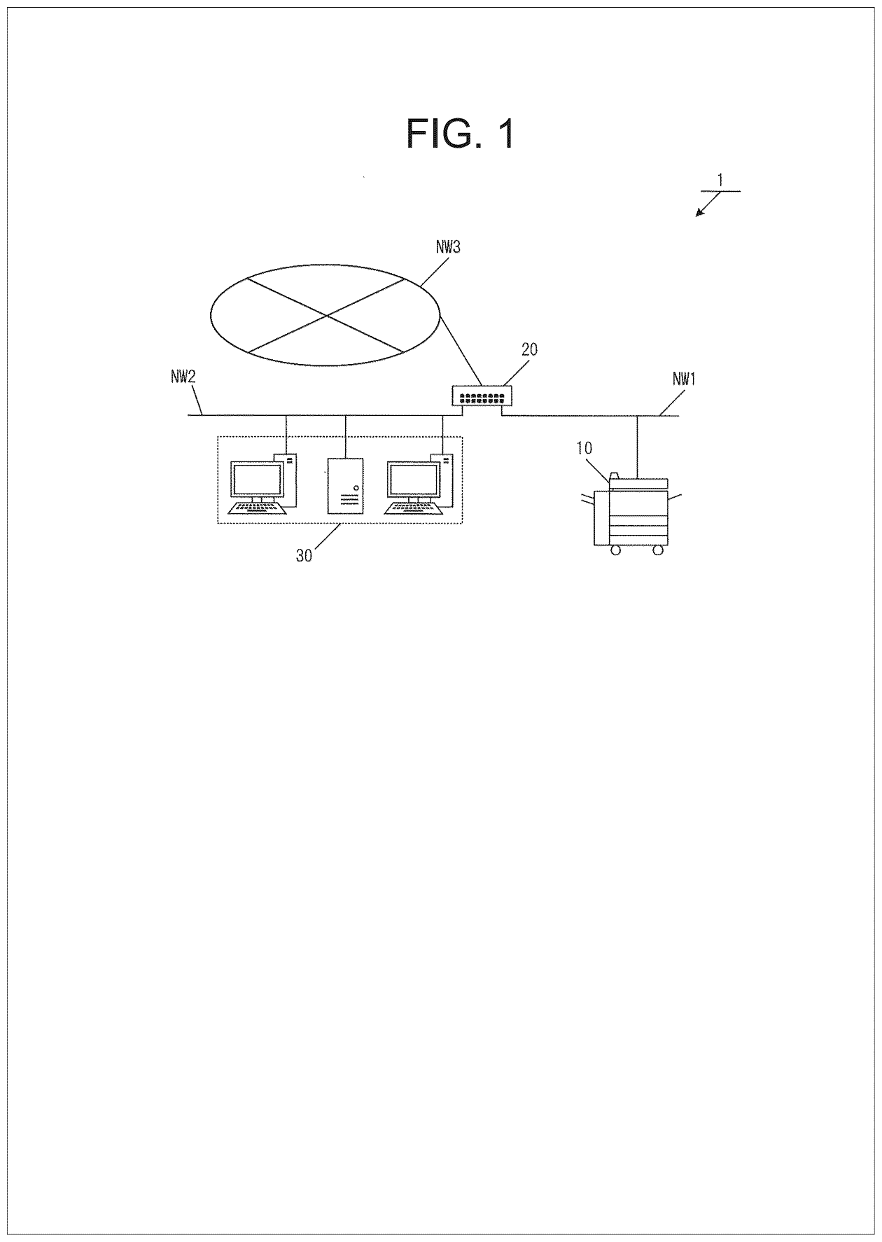

FIG. 1 is a diagram illustrating an overview of a system 1. The system 1 is a diagram illustrating an overview of the system 1 including an image forming apparatus 10.

The system 1 includes the image forming apparatus 10, a network device 20, and one or more terminal devices 30 capable of performing a communication via networks (NW1, NW2, and NW3).

The image forming apparatus 10 is, for example, a multifunction peripheral or an apparatus called a multifunction peripheral/printer/product (MFP). For example, in executing a job (print job), the image forming apparatus 10 is capable of forming an image on paper being a recording medium. The image forming apparatus 10 is capable of executing a job for a number of processing such as copy processing, fax processing, scanning processing, and printing processing.

The network device 20 is, for example, a device called a router, an L3 switch, or an L2 switch. The network device 20 includes one or more ports, and performs a communication between devices connected to the ports and networks (for example, the image forming apparatus 10, the terminal device 30, and the networks (NW1, NW2, and NW3)).

In the present embodiment, the network device 20 includes a loop sensing function. For example, upon sensing a state where a new network or a new device is connected or a communication speed of a device in the network changes so that a LAN link status changes, the network device 20 transmits a Spanning Tree Protocol (STP) packet to the network. Next, the network device 20 cuts off communication on the network until checking whether the network is looped is finished.

The terminal device 30 is, for example, a device used by a user or an administrator. For example, the user transmits a print job from the terminal device 30 to the image forming apparatus 10. The image forming apparatus 10 executes the received print job to print on the recording paper, based on print data, for example. The administrator is capable of, for example, setting the image forming apparatus 10 by accessing the image forming apparatus 10 from the terminal device 30.

The terminal device 30 is included in the system 1, as necessary. For example, one or more terminal devices 30 may be connected in the system 1. The terminal device 30 may be a server device, a network camera, or an IoT-compatible home appliance (a television, a video, and an air conditioner, for example).

The networks (NW1, NW2, and NW3) that connect the image forming apparatus 10, the network device 20, and the terminal device 30 may be any communication line or communication system, and may use, for example, a communication system such as a wired or wireless local area network (LAN), a virtual local area network (VLAN), the Internet, a public line network, a mobile communication (for example, a mobile communication such as 4G/5G/6G), and a next-generation telephone network.

### 1.2 Hardware Configuration

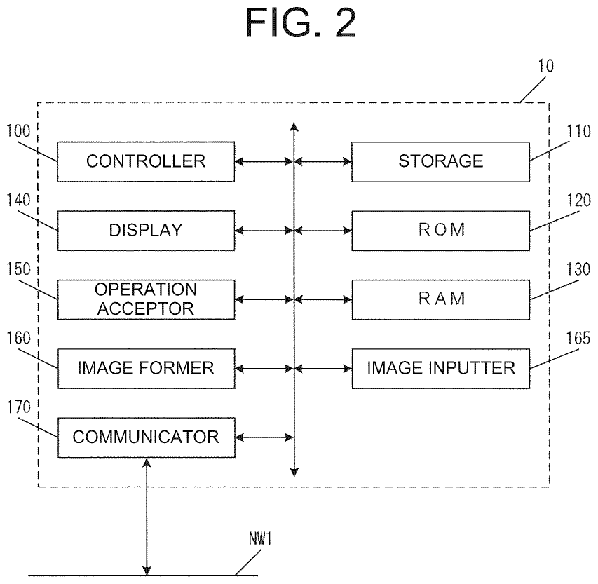

A hardware configuration of the image forming apparatus 10, which is a representative device among the devices in the system 1, will be described below with reference to the drawings. FIG. 2 is a diagram illustrating an example of the image forming apparatus 10.

As illustrated in FIG. 2, the image forming apparatus 10 includes a controller 100, a storage 110 serving as one or more storage devices (memories), a ROM 120 and a RAM 130, a display 140, an operation acceptor 150, an image former 160, an image inputter 165, and a communicator 170.

The controller 100 controls the entire image forming apparatus 10. The controller 100 realizes various types of functions by reading and executing various types of programs stored in the storage device (for example, the storage 110 and the ROM 120). The controller 100 may be realized by one or more control devices/arithmetic units (central processing units (CPUs) and System on a Chips (SoCs)). The controller 100 may include one or more control circuits.

The storage 110 is a non-volatile storage device capable of storing programs and data. For example, the storage 110 may include one or more storage devices such as a hard disk drive (HDD) or a solid state drive (SSD). The storage 110 may be configured as an external device such as a USB memory connectable to the image forming apparatus 10. The storage 110 may be, for example, a storage area on the cloud.

The ROM 120 is a non-volatile memory capable of retaining therein a program and data even when a power of the image forming apparatus 10 is cut.

The RAM 130 is a main memory mainly used by the controller 100 when the controller 100 executes processing. The RAM 130 is a rewritable memory that temporarily stores therein a program read from the storage 110 or the ROM 120, and data including a result during execution.

The display 140 is a display device capable of displaying various types of information and an execution screen. The display 140 may be, for example, a display device such as a liquid crystal display (LCD), an organic electroluminescence (EL) display, or an electrophoretic display. The display 140 includes an interface to which a display device is connected. For example, the display 140 may include an external display device connected via High-Definition Multimedia Interface (HDMI (registered trademark)), Digital Visual Interface (DVI), or Display Port.

The operation acceptor 150 is an operation device capable of accepting an operation input from a user. For example, the operation acceptor 150 may be an operation device such as a touch panel integrated with the display 140 or an operation button. The operation acceptor 150 may be an operation device such as a keyboard or a mouse. The operation acceptor 150 may include an interface (for example, a Universal Serial Bus (USB)) to which the operation device is connected. For example, the image forming apparatus 10 may be connected to a different operation device (operation device including a touch panel).

The image former 160 forms an image on, for example, recording paper. The image former 160 includes, for example, an image carrier, forms a toner image on the image carrier, and transfers the image on the image carrier onto the recording paper to form an image. The image former 160 may be configured as an image forming apparatus such as a printer. The image former 160 may electronically form an image as an image file.

The image inputter 165 reads an original document (image) and outputs such a document as image data. The image inputter 165 may be, for example, a scanner, and may be a reading device utilizing a charge coupled device (CCD) or a contact image sensor (CIS). It is noted that the image inputter 165 may be configured as an interface capable of acquiring image data stored in a storage medium such as a USB memory or image data transmitted from the terminal device 30 or the like.

The communicator 170 is a communication interface for communicating with other devices. For example, the communicator 170 may be a network interface capable of providing a wired connection or a wireless connection. In the present embodiment, the communicator 170 is capable of communicating with other devices via the network NW1.

It is noted that configurations of the network device 20 and the terminal device 30 are well-known, and thus, detailed explanations will be omitted. For example, the network device 20 and the terminal device 30 include at least a controller, a memory (a storage, ROM, RAM), and a communicator.

### 1.3 Software Configuration

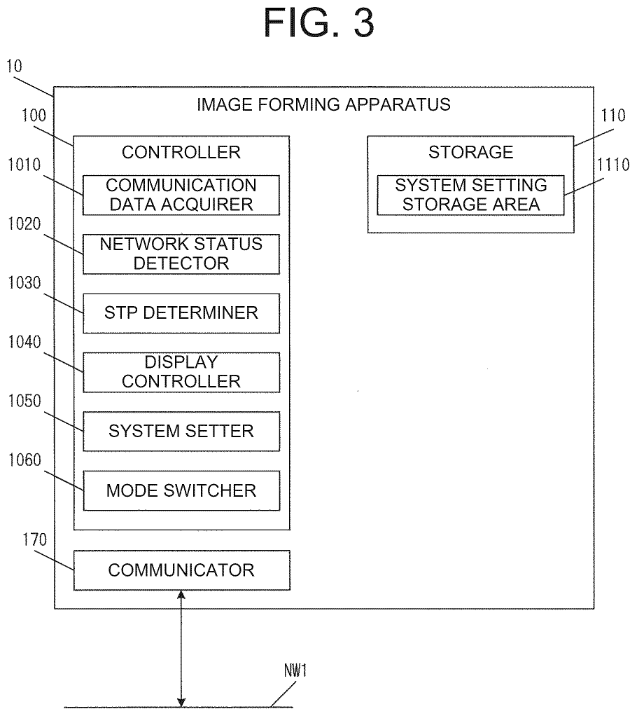

A configuration of a main software in each device in the system 1 will be described with reference to FIG. 3. FIG. 3 is a diagram illustrating a configuration of a main software of the image forming apparatus 10. It is noted that the software configuration illustrated in FIG. 3 mainly describes a configuration required in the present embodiment, and other configurations are omitted.

For example, the image forming apparatus 10 may further include a configuration for providing a functions required for the image forming apparatus 10, such as an image processing operator and a power controller.

For example, the controller 100 can read and execute a program stored in the storage (the storage 110 and the ROM 120) to function as a communication data acquirer 1010, a network status detector 1020, an STP determiner 1030, a display controller 1040, a system setter 1050, and a mode switcher 1060. The storage 110 also reserves an area of a system setting storage area 1110 where information related to a system setting is stored.

The communication data acquirer 1010 acquires communication data transmitted and received by the communicator 170 connecting to the network. For example, the communication data acquirer 1010 may acquire a packet, a frame, and the like as the communication data transmitted and received by the communicator 170, and temporarily store such data into the storage.

The network status detector 1020 detects a network status from the communication data acquired by the communication data acquirer 1010. For example, the network status detector 1020 detects a change in configuration of the network as the network status. For example, the network status detector 1020 may detect an STP packet, a Reverse Address Resolution Protocol (RARP) packet, a Gratuitous Address Resolution Protocol (GARP) packet, or the like to detect a change in configuration of the network.

If the network status detector 1020 detects a change in configuration of the network, the STP determiner 1030 determines whether the Spanning Tree Protocol is applied to the network. For example, the STP determiner 1030 may determine that the Spanning Tree Protocol is applied to the network by utilizing the STP packet such as a Bridge Protocol Data Unit (BPDU), a proposal BPDU, or an agreement BPDU.

The STP determiner 1030 may determine, in addition to determining that the Spanning Tree Protocol is applied to the network, that the extended STP is applied to the network, for example.

The display controller 1040 controls to display a message on the display 140. For example, the display controller 1040 controls display of a message or the like on the display 140, based on a result of the determination made by the STP determiner 1030.

The system setter 1050 sets a system of the image forming apparatus 10. The system setter 1050 is capable of switching the system setting in response to a user operation, and based on the result of the determination made by the STP determiner 1030, restricting a user operation of switching the system setting, for example.

The system setter 1050 executes a setting of the image forming apparatus 10, based on the system setting stored in the system setting storage area 1110 of the storage 110.

The mode switcher 1060 is capable of switching an operation mode of the image forming apparatus 10. The mode switcher 1060 is capable of switching the operation mode of the image forming apparatus 10 between, for example, a normal mode and a power saving mode. It is noted that switching from the normal mode to the power saving mode may be referred to as “transition to the power saving mode”, below. Switching from the power saving mode to the normal mode may be referred to as “recovery to the normal mode”.

Here, the normal mode refers to a mode in which, for example, all functions of the image forming apparatus 10 are operational and some of the functions, such as communication speed, are not restricted. The power saving mode is a mode in which less power is consumed (a mode in which a power is saved) compared to the normal mode. For example, in operating in the power saving mode, the image forming apparatus 10 performs one or more of the following controls in comparison with the normal operation mode.
Lower a temperature of a fixing device of the image former 160 (for example, to control a heater lamp to lower the temperature).
Slow down an image processing speed of the image former 160.
Dim or turn off a backlight of an operation panel.
Restrict an operation of the communicator 170. For example, slow down a communication speed or cut off a communication.

It is noted that control of the power saving in the power saving mode of the image forming apparatus 10 may be other general power saving control.

The mode switcher 1060 may switch the power saving mode between a plurality of modes. For example, the mode switcher 1060 may gradually switch from a first power saving mode to a second power saving mode in which less power is consumed.

The mode switcher 1060 switches the operation mode of the image forming apparatus 10 from the normal mode to the power saving mode when a predetermined condition (transition condition) is satisfied. Here, the mode switcher 1060 determines, as a predetermined condition (transition condition), for example, whether a time period elapses in which an idle time (a time period during which no operation is performed, a time period during which no processing is performed) satisfies a transition condition to the power saving mode.

The mode switcher 1060 switches the operation mode of the image forming apparatus 10 from the power saving mode to the normal mode when a predetermined condition (recovery condition) is satisfied. Here, the mode switcher 1060 may determine, as the predetermined condition (recovery condition), that the user operates the image forming apparatus 10 or that a job is submitted, for example.

The mode switcher 1060 is capable of switching the power saving mode, based on, as a transition condition, the result of the determination made by the STP determiner 1030, for example. The mode switcher 1060 may switch to the power saving mode, based on an operation by the user, regardless of the transition condition or the recovery condition. The mode switcher 1060 may restrict an operation for switching an operation mode from the user.

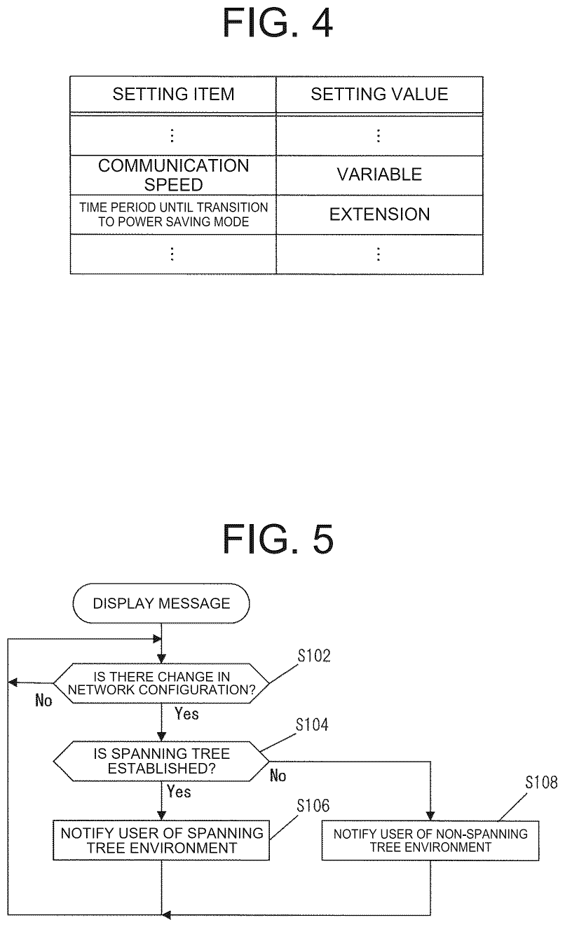

An example of the system setting stored in the system setting storage area 1110 will now be described with reference to FIG. 4. The system setting stores a setting item of the image forming apparatus 10 (for example, a “time period until transition to power saving mode”) and a setting value optionally input or selected (for example, “extension”).

In the present embodiment, a specific value such as “60 sec.”, “10 min.”, and “5 h.” may be stored in correspondence with the setting item “time period until transition to power saving mode”.

### 1.4 Processing Flow

A processing flow in the present embodiment will be described below with reference to FIG. 5. Although the following processing will be described as being executed by the controller 100, each configuration described with reference to FIG. 2 or FIG. 3 may execute the processing of each step.

First, the controller 100 detects whether there is a change in configuration of the network (S102). Here, the controller 100 may detect whether there is a change in configuration of the network by detecting, for example, an STP packet, a Reverse Address Resolution Protocol (RARP) packet, or a Gratuitous Address Resolution Protocol (GARP) packet in the communication data.

Next, when there is a change in configuration of the network, the controller 100 determines whether the Spanning Tree Protocol is applied to the network (S102; if Yes, processing proceeds to S104). On the other hand, if there is no change in configuration of the network, the controller 100 repeats the processing of S102 (S102; No).

In a method for the controller 100 to determine whether the Spanning Tree Protocol is applied to the network, the controller 100 may determine that the Spanning Tree Protocol is applied to the network when the communication data includes an STP packet such as a Bridge Protocol Data Unit (BPDU), a proposal BPDU, or an agreement BPDU.

On the other hand, when not capable of acquiring a packet related to the Spanning Tree Protocol for a predetermined time period, in spite of detection that there is a change in configuration of the network, the controller 100 determines that the Spanning Tree Protocol is not applied to the network to which the image forming apparatus 10 is connected. Here, the predetermined time period may be any time period including 10 milliseconds, 100 milliseconds, or 1 second.

Next, in determining that the Spanning Tree Protocol is applied to the network, the controller 100 displays a message on the display 140 indicating that the Spanning Tree environment is established, and notifies the user to such an effect (S104; if Yes, processing proceeds to S106).

In determining that the Spanning Tree Protocol is not applied to the network, the controller 100 displays a message on the display 140 indicating that a Non-Spanning Tree environment is established, and notifies the user to such an effect (S104; if No, processing proceeds to S108).

### 1.5 Example of Operation

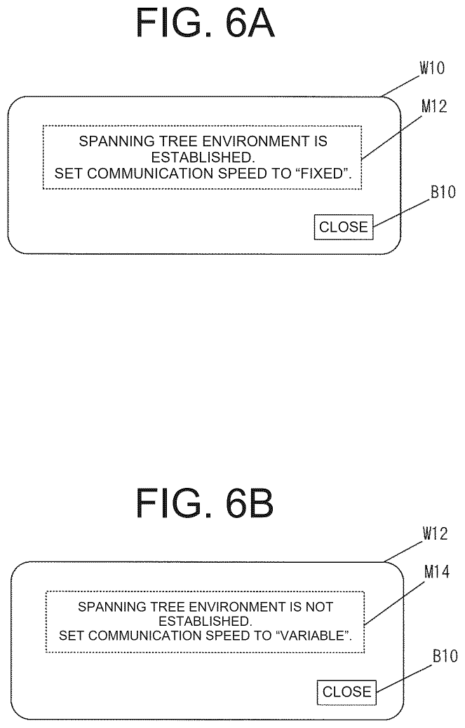

FIG. 6 is a diagram illustrating an example of a message displayed to a user as a result of an operation of the image forming apparatus 10 in the present embodiment.

FIG. 6A is a diagram illustrating an example of a display screen W10 displayed on the display 140. FIG. 6A is a diagram illustrating the display screen W10 being an example of a screen including a message displayed to the user if the network status detector 1020 detects that there is a change in configuration of the network and the STP determiner 1030 determines that the Spanning Tree environment is established. The display screen W10 is displayed thereon with a message M12 indicating that the Spanning Tree environment is established. At this time, when the user selects a button B10, the display screen W10 is closed and a current screen transitions to another screen.

Based on the displayed message, the user is capable of switching the setting information such as the communication speed from a setting screen (not illustrated). The button B10 may be hidden in the display screen W10. When the button B10 is displayed, the display screen W10 may be closed by the user simply touching the screen.

FIG. 6B is a diagram illustrating an example of a display screen W12 displayed on the display 140. FIG. 6B is a diagram illustrating an example of a message displayed to the user if there is a change in configuration of the network and the STP determiner 1030 determines that the non-Spanning Tree environment is established. The display screen W12 is displayed thereon with a message M14 to the effect that the Spanning Tree environment is not established.

In the present embodiment, the message is displayed on the display 140, however, a notification may be displayed from a software and an application resident on the terminal device 30 connected via the network NW1 such as an information processing apparatus and a mobile communication terminal device including a smartphone, a smart watch, and a tablet terminal.

### 1.6 Effects and the Like

Thus, according to the present embodiment, the controller 100 is capable of checking whether the Spanning Tree environment is applied to the network to which the image forming apparatus 10 is connected. For example, the user is capable of selecting an appropriate power saving setting, based on the displayed message.

### 2. Second Embodiment

A second embodiment will be described below. In the second embodiment, a setting screen for changing the communication speed is displayed after a message is displayed.

In the second embodiment, the description will be omitted for the components including the same hardware and software configuration as the first embodiment, and the description will focus on the points different from the first embodiment.

### 2.1 Processing Flow

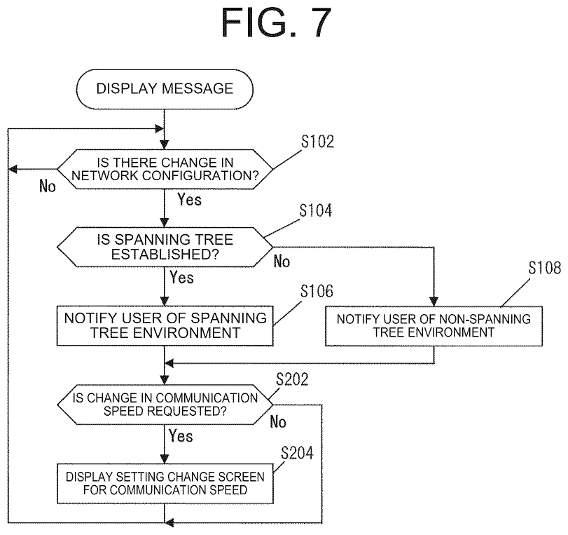

FIG. 7 is a diagram illustrating a flow of processing in the present embodiment. FIG. 7 provides an addition to FIG. 5 of the first embodiment. In FIGS. 7, S202 and S204 are executed after S106 and S108 in FIG. 5.

If the controller 100 displays, to the user, a message indicating whether the Spanning Tree environment is established, and then, the user requests a change in communication speed, the controller 100 displays a setting screen for changing the communication speed (S202; if Yes, processing proceeds to S204). Here, displaying a setting screen for changing the communication speed means displaying a below-described screen, for example.

(1) The controller 100 displays a setting screen at a position displayed with a setting item to be changed, on a setting screen including a plurality of setting items. For example, when a “communication speed” is changed for a setting item, the controller 100 scrolls (jumps) to a position displayed with the setting item “communication speed” for a setting item, and displays the setting screen.

(2) The controller 100 displays a setting screen displaying thereon with a setting items to be changed. For example, when the “communication speed” is changed for a setting item, a single screen for changing such a setting item is displayed.

On the other hand, if the user does not request a change in communication speed, the controller 100 executes processing of S102 again (S202; if No, the processing proceeds to S102).

### 2.2 Example of Operation

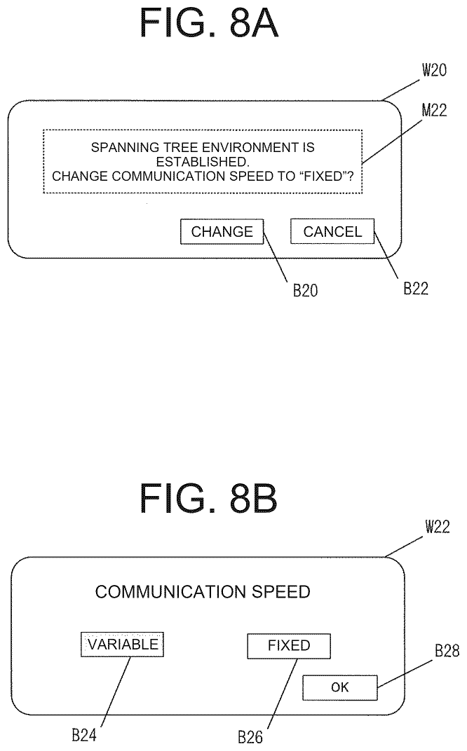

FIG. 8 is a diagram illustrating an example of a message displayed to a user as a result of the operation of the image forming apparatus 10 in the present embodiment.

FIG. 8A is a diagram illustrating an example of a display screen W20 including a message to be displayed to a user when there is a change in configuration of the network and the STP determiner 1030 determines that the Spanning Tree environment is established. The display screen W20 is displayed thereon with a message M22 indicating that the Spanning Tree environment is established. A change button B20 and a cancel button B22 are also displayed on the display screen W20. When a user selects the cancel button B22, the controller 100 simply closes the display screen W20.

When a user selects the change button B20, the controller 100 transitions the display screen W20 to a display screen W22 of FIG. 8B. FIG. 8B is a diagram illustrating the display screen W22 being an example of a user interface displayed if the change button B20 in FIG. 8A is selected by the user. The display screen W22 displays a single setting screen for switching a communication speed setting among the setting items. The display screen W22 displays a button corresponding to a setting value. For example, a button B24 corresponds to a setting value “variable”. A button B26 corresponds to a setting value “fixed”. Because of a current setting value being “variable”, the button B24 is displayed in an identifiable manner.

When the user selects the button B26, the controller 100 changes the setting value of the setting item “communication speed” to “fixed”. This allows the user to switch the communication speed to “fixed” when the Spanning Tree is applied to the network. Thus, the user is capable of appropriately switching the setting value, based on the user's own network configuration.

In the present embodiment, the message is displayed on the display 140, however, a notification may be displayed from a software and an application resident on the terminal device 30 connected via the network NW1 such as an information processing apparatus and a mobile communication terminal device including a smartphone, a smart watch, and a tablet terminal, and a change operation may be accepted therefrom.

In the present embodiment, the message is displayed if the Spanning Tree environment is established, and the user interface is displayed if the user requests a change in communication speed. Here, for example, if the user is restricted by a system administrator from changing the communication speed, when the STP determiner 1030 determines that the Spanning Tree environment is established, a control may be performed to cancel restriction of a change in communication speed.

### 2.3 Effects and the Like

Thus, according to the present embodiment, in addition to the effects of the first embodiment, the user is allowed to be relieved from a trouble of having to select the communication speed from a number of settings, and thus, it is possible to improve a usability.

### 3. Third Embodiment

A third embodiment will be described below. In the third embodiment, a control is performed, for example, to significantly extend a time period until transition to a power saving mode after the message is displayed.

In the third embodiment, the description will be omitted for the components including the same hardware and software configuration as the first embodiment, and the description will focus on the points different from the first embodiment.

### 3.1 Processing Flow

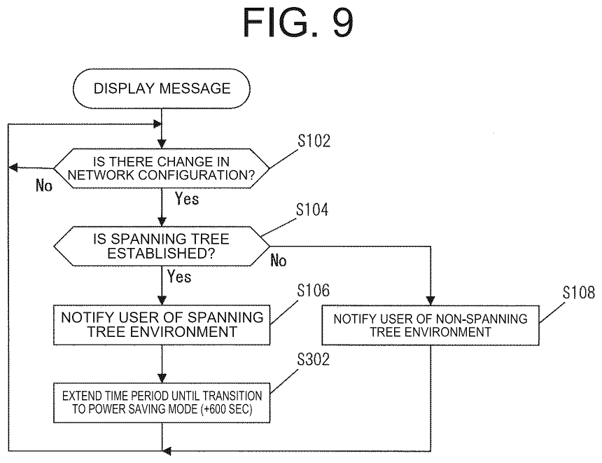

FIG. 9 is a diagram illustrating a flow of processing in the present embodiment. FIG. 9 provides an addition to FIG. 5 of the first embodiment. S302 is executed after S106 in FIG. 5.

After displaying the message to the user indicating that the Spanning Tree environment is established, the controller 100 performs processing to extend a time period until transition to a power saving mode (S302). It is preferable that the controller 100 significantly extends a time period until transition to a power saving mode. For example, the controller 100 may extend a currently set time period until transition by “+600 seconds (+10 minutes)”, “+30 minutes”, or “+5 hours”. For example, a time period until transition is preferably a time period during which no effect of communication interruption is caused.

### 3.2 Example of Operation

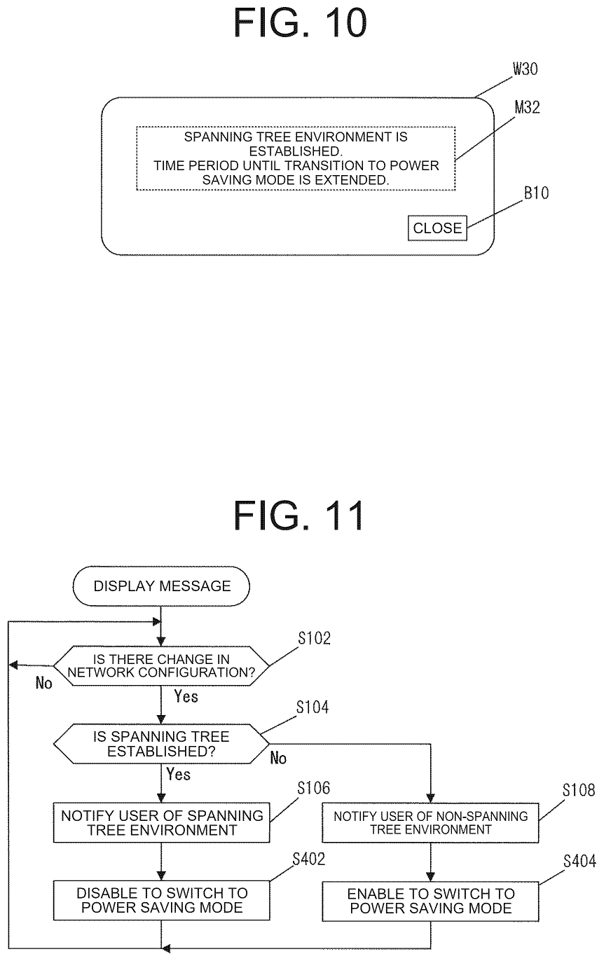

FIG. 10 is a diagram illustrating an example of a display screen W30 displayed on the display 140. FIG. 10 is a diagram illustrating the display screen W30 being an example of a screen including a message displayed to the user if the network status detector 1020 detects that there is a change in configuration of the network and the STP determiner 1030 determines that the Spanning Tree environment is established. The display screen W30 displays a message M32 indicating that the Spanning Tree environment is established and that a time period to transition to the power saving mode is extended. At this time, when the user selects the button B10, the display screen W30 is closed and a current screen transitions to another screen. At this time, the controller 100 also displays the message and performs processing for extending a time period until transition to a power saving mode.

Based on the displayed message, the user may be capable of switching information on a setting such as a time period until transition to a power saving mode from a setting screen (not illustrated). It is noted that the button B10 may not be displayed on the display screen W30. When the button B10 is displayed, the display screen W30 may be closed by the user simply touching the screen.

### 3.3 Effects and the Like

Thus, according to the third embodiment, in addition to the effects of the first embodiment, it is possible to perform a control to significantly extend a time period until transition to a power saving mode. With such a control, it is possible to significantly reduce an impact of communication interruption and the like. When the user is notified from the image forming apparatus 10 that a time period until transition to a power saving mode is extended, the user can freely change the setting if there is a problem with the control of switching to the power saving mode.

### 4. Fourth Embodiment

A fourth embodiment will be described below. In the fourth embodiment, after the message is displayed, a control is performed to switch between availability and unavailability to transition to the power saving mode, based on a result of the determination by the STP determiner 1030.

In the fourth embodiment, the description will be omitted for the components including the same hardware and software configuration as the first embodiment, and the description will focus on the points different from the first embodiment.

### 4.1 Processing Flow

FIG. 11 is a diagram illustrating a flow of processing in the present embodiment. FIG. 11 provides an addition to FIG. 5 of the first embodiment. After S106 and S108 in FIGS. 5, S402 and S404 are executed, respectively.

In determining that the Spanning Tree Protocol is applied to the network, the controller 100 displays the message, to the user, indicating that the Spanning Tree environment is established, and then performs processing not to allow switching to the power saving mode (S402). That is, the image forming apparatus 10 does not transition to the power saving mode.

In determining that the Spanning Tree Protocol is not applied to the network, the controller 100 displays the message to the user indicating that the Spanning Tree environment is not established, and then performs processing to allow switching to the power saving mode (S404). That is, the image forming apparatus 10 is capable of transitioning to the power saving mode when a predetermined condition is satisfied.

### 4.2 Example of Operation

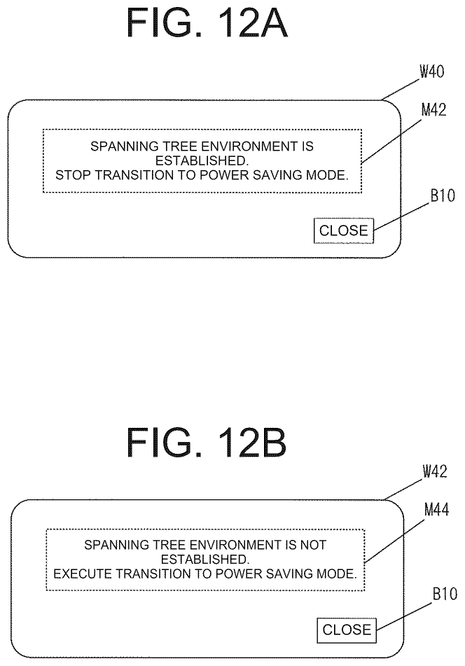

FIG. 12 is a diagram illustrating an example of the message displayed to the user as a result of the operation of the image forming apparatus 10 in the present embodiment.

FIG. 12A is a diagram illustrating an example of a display screen W40 displayed on the display 140. FIG. 12A is a diagram illustrating the display screen W40 being an example of a screen including a message displayed to the user if the network status detector 1020 detects that there is a change in configuration of the network and the STP determiner 1030 determines that the Spanning Tree environment is established. The display screen W40 is displayed thereon with a message M42 indicating that the Spanning Tree environment is established. At this time, when the user selects the button B10, the display screen W40 is closed and a current screen transitions to another screen.

At this time, the controller 100 performs a control so that the operation mode of the image forming apparatus 10 is not switched to the power saving mode. It is noted that for example, after the message is displayed, the user may perform an operation to change the setting to switch to the power saving mode, or a button or the like may be displayed on the display screen W40 so that the user can easily change the control.

FIG. 12B is a diagram illustrating an example of a display screen W42 displayed on the display 140. FIG. 12B is a diagram illustrating the display screen W42 being an example of a screen including a message displayed to the user if the network status detector 1020 detects that there is a change in configuration of the network and the STP determiner 1030 determines that the Non-Spanning Tree environment is established. The display screen W42 is displayed thereon with a message M44 to the effect that the Spanning Tree environment is not established. At this time, when the user selects the button B10, the display screen W42 is closed and a current screen transitions to another screen.

At this time, the controller 100 also performs a control to switch the operation mode of the image forming apparatus 10 to the power saving mode. It is noted that, for example, after the message is displayed, the user may perform an operation to change the setting not to switch to the power saving mode, or a button or the like may be displayed on the display screen W42 so that the user can easily change the control.

### 4.3 Effects and the Like

Thus, according to the present embodiment, in addition to the effects of the first embodiment, the image forming apparatus 10 is capable of performing a control, for example, not to transition to the power saving mode when the Spanning Tree environment is established. When the image forming apparatus 10 transitions to the power saving mode, the communication environment changes, causing the Spanning Tree network to be reconfigured. Therefore, when the image forming apparatus 10 is prevented from transitioning to the power saving mode, the network configuration is maintained, and an influence of a communication interruption and the like can be significantly reduced. With the notification, the user can freely change the setting if there is a problem with the control.

### 5. Fifth Embodiment

A fifth embodiment will be described below. In the fifth embodiment, after displaying the message, the control of switching to the power saving mode described in the second and fourth embodiments is selected according to a request of a user.

In the fifth embodiment, the description will be omitted for the components including the same hardware and software configuration as the first embodiment, and the description will focus on the points different from the first embodiment, the second embodiment, and the fourth embodiment.

### 5.1 Processing Flow

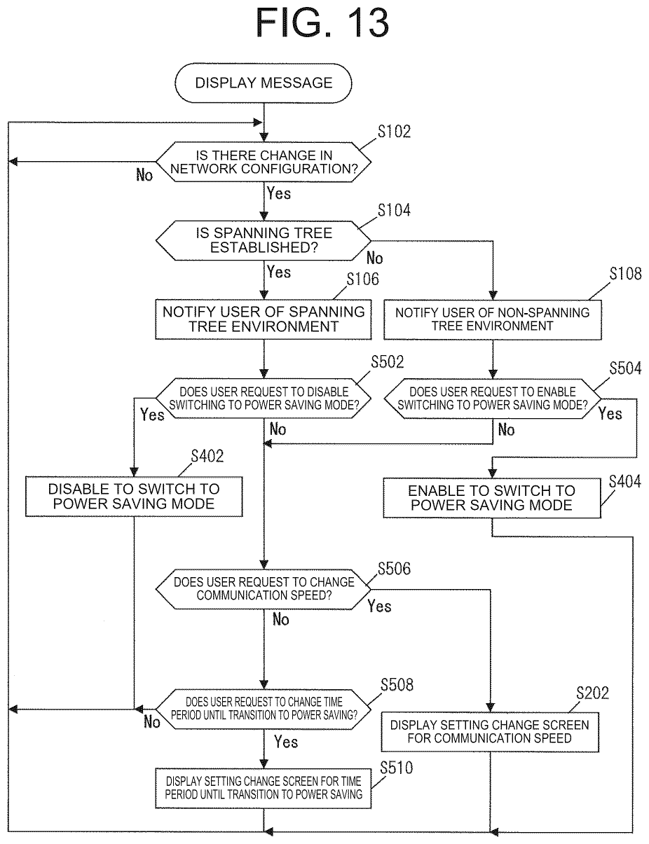

FIG. 13 is a diagram illustrating a flow of processing in the present embodiment. FIG. 13 provides an addition to FIG. 5 of the first embodiment. After S106 and S108 in FIGS. 5, S502 and S504 are executed, respectively. If results of S502 and S504 are both No, S506, S508 and S510 are executed.

The controller 100 displays a message to the user indicating that the Spanning Tree environment is established, and also displays a message for asking the user whether to disable switching to the power saving mode. If the user requests a change to disable switching to the power saving mode, the controller 100 performs a control, for example, not to transition to the power saving mode (S502; if Yes, the processing proceeds to S402).

The controller 100 displays a message to the user indicating that the Spanning Tree environment is not established, and also displays a message for asking the user whether to enable switching to the power saving mode. If the user requests a change to enable switching to the power saving mode, the controller 100 performs a control, for example, to transition the power saving mode (S504; if Yes, the processing proceeds to S404).

If the user does not request switching to the power saving mode, the display 140 displays whether to request a change in communication speed. If the user requests a change in communication speed, a setting screen for changing the communication speed is displayed (S506; if Yes, the processing proceeds to S202).

If the user does not request a change in communication speed, a message for asking the user whether to request a change in time period until transition to a power saving mode is displayed on the display 140 (S506; if No, the processing proceeds to S508). If the user requests a change in time period until transition to a power saving mode, a setting screen for changing a time period until transition to a power saving mode is displayed (S508; if Yes, the processing proceeds to S510).

It is noted that the above-described operational flow is an example, and some different processing may be performed. For example, an order of the setting for whether to enable/disable switching to the power saving mode, the communication speed, and a time period until transition to a power saving mode may be changed, and a setting screen for allowing to change both the communication speed and the time period until transition to a power saving mode may be displayed and combined into one step.

### 5.2 Example of Operation

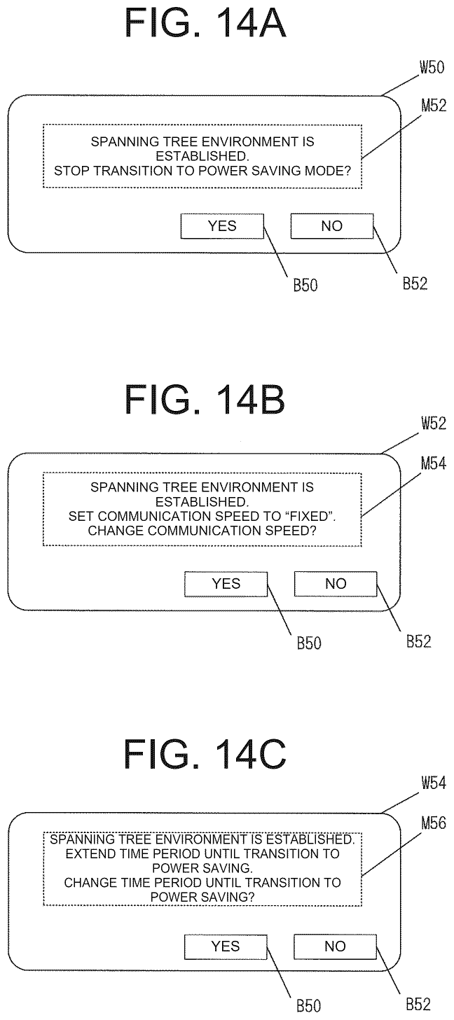

FIG. 14 is a diagram illustrating an example of the message displayed to the user as a result of the operation of the image forming apparatus 10 in the present embodiment.

FIG. 14A is a diagram illustrating an example of a display screen W50 displayed on the display 140. FIG. 14A is a diagram illustrating the display screen W50 being an example of a screen including a message displayed to the user if the network status detector 1020 detects that there is a change in configuration of the network and the STP determiner 1030 determines that the Spanning Tree environment is established. A message M52 for indicating that the Spanning Tree environment is established and asking the user whether to stop transitioning to the power saving mode is displayed on the display screen W50. A Yes button B50 and a No button B52 are also displayed on the display screen W50. When the user selects the Yes button B50, the controller 100 performs a control not to transition to the power saving mode. On the other hand, when the user selects the No button B52, the controller 100 transitions the display screen W50 to a display screen W52 of FIG. 14B.

FIG. 14B is a diagram illustrating an example of the display screen W52 displayed on the display 140. FIG. 14B is a diagram illustrating the display screen W52 being an example of a screen including a message displayed to the user if the user selects the No button B52 on the display screen W50. A message M54 for indicating that the Spanning Tree environment is established and asking the user whether the communication speed is changed to a fixed speed is displayed on the display screen W52. The Yes button B50 and the No button B52 are also displayed on the display screen W52. When the user selects the Yes button B50, the controller 100 transitions the display screen W52 to the display screen W22 of FIG. 8B, for example.

Here, if the Yes button B50 is selected, for example, the controller 100 may perform a control to change to a set value for setting the communication speed to “fixed”. On the other hand, when the user selects the No button B52, the controller 100 transitions the display screen W52 to a display screen W54 of FIG. 14C.

FIG. 14C is a diagram illustrating an example of the display screen W54 displayed on the display 140. FIG. 14C is a diagram illustrating the display screen W54 being an example of a screen including a message displayed to the user if the user selects the No button B52 on the display screen W52. A message M56 for indicating that the Spanning Tree environment is established and asking the user whether to extend a time period until transition to a power saving mode is displayed on the display screen W54. The Yes button B50 and the No button B52 are also displayed on the display screen W54. When the user selects the Yes button B50, the controller 100 transitions the display screen W54 to a setting screen (not illustrated) for changing a time period until transition to a power saving mode, for example.

When the Yes button B50 is selected, for example, the controller 100 may perform a control to change to a set value for setting a time period until transition to a power saving mode to “extend”. On the other hand, if the user selects the No button B52, the controller 100 simply closes the display screen W54.

### 5.3 Effects and the Like

Thus, according to the present embodiment, in addition to the effect of the first embodiment, the user is capable of selecting an optimal setting from a plurality of settings according to the message.

### 6. Sixth Embodiment

A sixth embodiment will be described below. In the sixth embodiment, processing is switched depending on a protocol applied even in the Spanning Tree environment. If the Spanning Tree Protocol is applied to the network, the STP determiner 1030 determines whether the RSTP or the MSTP is applied, displays a message, and then, switches to an optimal power saving mode.

In the sixth embodiment, the description will be omitted for the components including the same hardware and software configuration as the first embodiment and the fourth embodiment, and the description will focus on the points different from the first embodiment.

### 6.1 Processing Flow

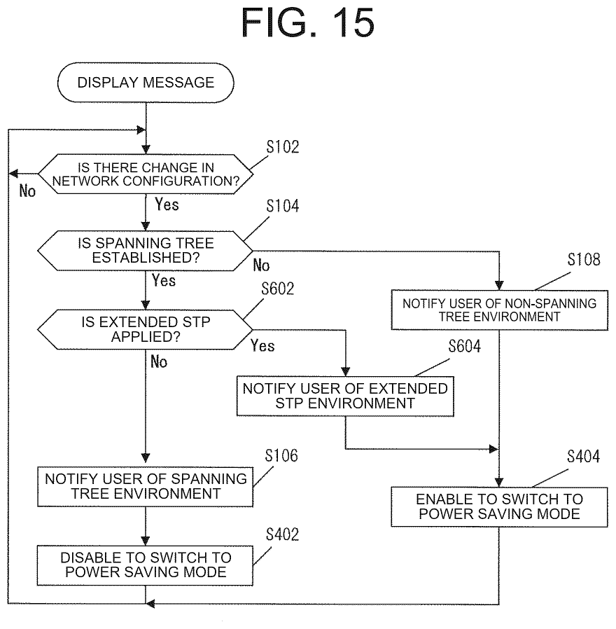

FIG. 15 is a diagram illustrating a flow of processing in the present embodiment. FIG. 15 provides an addition to FIG. 11 of the fourth embodiment. S602 is executed after S104 in FIG. 11, S604 is executed if Yes in S602, S404 is executed after S108 is executed, and S402 is executed after S106 is executed.

In determining that the Spanning Tree Protocol is applied to the network, the controller 100 then determines whether the extended STP is applied to the network (S602).

For the controller 100 to determine whether the extended STP is applied to the network, the controller 100 may determine that the extended STP is applied to the network when the communication data includes a packet such as a proposal BPDU or an agreement BPDU.

On the other hand, in determining that the Spanning Tree Protocol is applied but being unable to acquire the packet related to the extended STP for a predetermined time period, the controller 100 determines that the extended STP is not applied to the network to which the image forming apparatus 10 is connected. Here, the predetermined time period may be any time period including 10 milliseconds, 100 milliseconds, or 1 second.

In determining that the network is applied with the extended STP environment, the controller 100 displays, to the user, a message indicating that the network is in the extended STP environment (S602; if Yes, the processing proceeds to S604).

Next, if the Spanning Tree Protocol is not applied to the network, or if the extended STP is applied to the network, the controller 100 performs processing to enable switching to the power saving mode (S602; if Yes, the processing proceeds to S604, and the processing proceeds to S404).

In determining that the extended STP is not applied to the network, the controller 100 displays, on the display 140, a message indicating that the network is in the Spanning Tree environment and notifies the user to such an effect (S602; if No, the processing proceeds to S106).

It is noted that the above-described operational flow is an example, and some different processing may be performed. In the present embodiment, the controller 100 determines that the extended STP is applied to the network, but, for example, steps S104 and S602 may be combined to form a flow in which each of the Spanning Tree Protocol, the extended STP, and the non-Spanning Tree Protocol is determined together.

### 6.2 Example of Operation

In the sixth embodiment, if the network status detector 1020 detects that there is a change in configuration of the network and the STP determiner 1030 determines that the extended STP environment is established, the controller 100 displays a message to be displayed to the user and then switches to the power saving mode.

### 6.3 Effects and the Like

Thus, according to the present embodiment, the user can select a setting for switching an appropriate power saving mode according to the network configuration by simply performing an operation in accordance with the displayed messages.

### 7. Modification

The present disclosure is not limited to the above-described embodiments, and various modifications are possible. That is, embodiments obtained by combining technical means appropriately modified within the scope not deviating from the gist of the present disclosure are also included in the technical scope.

In the above-described embodiments, the image forming apparatus is described as an example of an information processing apparatus. However, the information processing apparatus may be applied to other devices. For example, an example of the information processing apparatus may include an information processing apparatus such as a smartphone or a tablet. An example of the information processing apparatus may also include a home appliance including an IoT function (for example, an air conditioner, a refrigerator, and a television). The information processing apparatus is not limited to a stationary apparatus, but may also be, for example, a portable apparatus or a vehicle-mounted apparatus. For example, an example of the vehicle-mounted apparatus may include a car navigation system.

Although the above-described embodiments are described separately for convenience of explanation, such embodiments may be combined and executed where possible. It is intended to acquire a right to any of the technologies described herein through an amendment or a divisional application and the like.

A program running on each device in each embodiment is a program that controls a CPU and the like (a program that causes a computer to function) to realize the above-described functions of the embodiments. The information handled in the device is temporarily accumulated in a temporary storage device (for example, a RAM) during processing, and is then stored in various types of storage devices such as a ROM and an HDD, and is read, modified, and written by the CPU, as necessary.

Here, a recording medium for storing a program may be any of a semiconductor medium (for example, a ROM and a non-volatile memory card), an optical recording medium/magneto-optical recording medium (for example, a digital versatile disc (DVD), a compact disc (CD), and a Blu-ray (registered trademark) disc (BD)), a magnetic recording medium (for example, a magnetic tape and a flexible disk), and the like.

In distributing a program on a market, the program can be stored on a portable recording medium and distributed, or transferred to a server computer connected via a network such as the Internet. In such a case, it goes without saying that the storage device of the server device is also included in the present disclosure.

The above-mentioned data may not be stored within the device, but may be stored in an external device and called as necessary. For example, the data may be stored in a network attached storage (NAS) or on the cloud.

The scope of the present disclosure is not limited to the configurations or structures explicitly described herein, but also includes combinations of the technologies disclosed herein. The configurations of the present disclosure to be patented are set forth in the appended claims, but it is not intended that the configurations be excluded from the technical scope because the configurations are not set forth in the claims.

In the above-mentioned specification, the statements “if” and “when” are explained in an example, and are not intended to be limited to the contents described. The present disclosure also discloses configurations other than those mentioned above, to the extent that these would be obvious to a person skilled in the art, and intends to obtain rights to such configurations.

The processing and flows of data described herein that are sequential are not limited to being performed in the order described. For example, the applicant discloses configurations in which some parts of the processing are deleted or the order is changed, and the applicant intends to obtain rights to such configurations.

Although the functions described in the embodiments are executed by each device, the functions may be realized by one device, or an external server may be further used.

Each functional block or feature of the apparatus used in the above-described embodiments may be implemented or performed in an electric circuit, for example, an integrated circuit or a plurality of integrated circuits. An electric circuit designed to execute the functions described herein may include a general purpose processor, a digital signal processor (DSP), an application specific integrated circuit (ASIC), a field programmable gate array (FPGA) or another programmable logic device, a discrete gate or a transistor logic, a discrete hardware component, or any combination thereof. The general purpose processor may be a microprocessor, or any known processor, controller, microcontroller, or state machine. The above-mentioned electric circuit may include a digital circuit or an analog circuit. If an integrated circuit technology replacing current integrated circuits emerges due to advances in semiconductor technology, one or more aspects of the present disclosure may also use a new integrated circuit based on that technology.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An information processing apparatus, comprising:
a communicator that connects to a network to transmit and receive communication data;
a detector that detects a change in configuration of the network from the communication data received by the communicator;
a determiner that determines, from the communication data, whether a Spanning Tree Protocol is applied to the network; and
a display that displays a message to a user, based on a result of the determination made by the determiner.

2. The information processing apparatus according to claim 1, further comprising:
a switcher that switches between a normal mode and a power saving mode, wherein
the display displays a message about whether the switcher switches to the power saving mode, based on the result of the determination made by the determiner.

3. The information processing apparatus according to claim 2, wherein in determining that a Spanning Tree Protocol is applied to the network, the determiner disables the switcher from switching to the power saving mode.

4. The information processing apparatus according to claim 2, wherein in determining that a Spanning Tree Protocol is not applied to the network, the determiner enables the switcher to switch to the power saving mode.

5. The information processing apparatus according to claim 2, wherein in determining that an extended STP is applied to the network, the determiner enables the switcher to switch to the power saving mode.

6. The information processing apparatus according to claim 1, further comprising:
a setter that sets a communication speed of the communicator, wherein
the display displays a message for prompting display of a setting screen for setting the communication speed, based on the result of the determination made by the determiner.

7. The information processing apparatus according to claim 6, wherein the display further displays, in the setting screen, a display for accepting an input for transitioning to a screen for setting the communication speed.

8. The information processing apparatus according to claim 1, further comprising:
a switcher that switches between a normal mode and a power saving mode; and
a setter that sets a time period until transition to the power saving mode, wherein
the display displays a message, based on the result of the determination made by the determiner, and
the setter extends the time period until transition to the power saving mode.

9. The information processing apparatus according to claim 1, further comprising:
a switcher that switches between a normal mode and a power saving mode; and
a setter that sets a time period until transition to the power saving mode, wherein
the display displays a message for prompting display of a setting screen for setting the time period until transition to the power saving mode, based on the result of the determination made by the determiner.

10. The information processing apparatus according to claim 9, wherein the display further displays, in the setting screen, a display for accepting an input for transitioning to a screen for setting the time period until transition to the power saving mode.

11. A display method, comprising:
connecting to a network to transmit and receive communication data;
detecting a change in configuration of the network;
determining whether a Spanning Tree Protocol is applied to the network; and
displaying a message to a user, based on a result of the determination made in the determining.
